(19) United States
(12) Patent Application Publication
(10) Pub. No.: US 2008/0178079 A1
(43) Pub. Date: Jul. 24, 2008

(54) APPARATUS AND METHOD FOR A GRAPHICAL USER INTERFACE TO FACILITATE TUNING SQL STATEMENTS

(75) Inventors: Chi Chen, Beijing (CN); Qing Li, Beijing (CN); Kevin Michael McBride, Mountain View, CA (US); Tai Wei Shi, Beijing (CN); Fang Xing, Beijing (CN); Zhuo Zhang, Beijing (CN)

Correspondence Address: Kunzler & McKenzie, 8 EAST BROADWAY, SUITE 600, SALT LAKE CITY, UT, 84111, US

(73) Assignee: INTERNATIONAL BUSINESS MACHINES CORPORATION, ARMONK, NY (US)

(21) Appl. No.: 11/624,539

(22) Filed: Jan. 18, 2007

(51) Int. Cl. G06F 3/00

(52) U.S. Cl. 715/700

(57) ABSTRACT

A computer program product, apparatus, method, and system for SQL tuning analysis runs an SQL advisor summary process using predetermined SQL tuning advisors on a user selected SQL statement, generates an advisor summary containing a prioritized list of the predetermined SQL tuning advisors and a first user selectable component, and generates, when the user selects the first user selectable component, recommended action details containing advisor specific SQL tuning recommendations for a selected SQL tuning advisor from the advisor summary and a second user selectable component. The present invention runs an advisor specific SQL tuning process when the user selects the second user selectable component from the recommended action details, and generates another advisor summary containing prioritized SQL tuning advisors based upon the SQL after running the advisor specific SQL tuning process.

### BACKGROUND OF THE INVENTION

1. Field of the Invention

This invention relates to improving SQL performance, and more particularly, the present invention relates to an SQL analysis tool that provides a prioritized summary of recommended actions, the summary includes visual indicators of the importance of recommended actions.

2. Description of the Related Art

Many businesses have relational databases that are generally accessed through Structured Query Language (SQL). The speed and efficiency with which SQL accesses the desired data affects the operating cost and application availability of the database systems. For example, slow running SQL can require more hardware and increase monthly software usage costs. Additionally, if the frequency of an SQL database operation is greater than the execution time of the SQL operation, then a backlog of operations occurs and the application executing the SQL operations, along with other applications on the system, becomes unavailable or at least less responsive to users.

Conventionally, this challenge was addressed through performance tuning of the SQL. Conventional performance tuning of the SQL is generally configured to help the SQL to execute more quickly and to consume fewer system resources. However, SQL performance tuning requires significant skill and experience, and given that the complexity of SQL continues to increase to meet more complex business requirements, generally speaking, most database administrators and applications developers do not have the skill or time required to properly tune their SQL.

Database tools vendors have attempted to address this challenge by providing tools that automate the analysis of SQL and provide recommendations for indexes, SQL rewrites, or other design elements that affect SQL performance. However, the use of conventional SQL tools still requires significant SQL programming/tuning knowledge and skill to choose the correct sequence of recommendations and to implement the correct recommendations made by the analysis tool, as an incorrect evaluation sequence or implementation of the wrong recommendation will generally reduce the efficiency of the SQL, thus exacerbating the problem.

Companies that provide SQL analysis tools have attempted to address these challenges; however, SQL analysis tools provided by these companies provide recommendations for fixing problems related to SQL performance without any sort of high level summary or organization/prioritization/categorization of the suggested corrective actions. Rather, each of the conventional SQL analysis tools provided presents lists of SQL related recommendations, but does not present a high level summary or recommendation on the hierarchy, priority, or ordering of the recommended actions among different advisors or among actions within advisors.

### SUMMARY OF THE INVENTION

From the foregoing discussion, it should be apparent that a need exists for an apparatus, system, and method for SQL analysis that provides an easily readable high level summary of the SQL analysis and provides a prioritized list of recommended corrective actions to improve the performance of the SQL. Beneficially, such an apparatus, system, and method would guide the user through the most appropriate order for implementing recommended SQL tuning actions, thus ensuring that the SQL analysis takes into account the best available data, is optimized, and does not further degrade the performance of the SQL via incorrect tuning actions.

The present invention has been developed in response to the present state of the art, and in particular, in response to the problems and needs in the art that have not yet been fully solved by currently available SQL analysis tools. Accordingly, the present invention has been developed to provide an apparatus, system, and method for conducting SQL analysis that overcomes many or all of the above-discussed shortcomings in the art.

More particularly, embodiments of the present invention solve the challenges associated with conventional SQL analysis tools by providing an SQL analysis tool that includes an easy to use graphical user interface (GUI) configured to prioritizing the sequence and importance of the SQL tuning recommendations to be implemented. Embodiments of the invention overcome the deficiencies of the prior art by selectively calling one or more of multiple SQL advisor tools, which may be a statistics advisor, an index advisor, a materialized query table (MQT) advisor, a resource advisor, and/or a query advisor, and coordinating the SQL tuning recommendations to guide a user through a sequence of recommendation implementations that will result in an efficient solution to the SQL tuning problem. In one embodiment of the present invention, a computer program product summarizes advice from a plurality of SQL advisors and coordinate, and prioritizes implementation of the advice from the plurality of SQL advisors for a specific SQL statement. The computer program product causes the computer to: present a set of user selectable SQL statements associated with a particular relational database; select one or more SQL statements for tuning in response to user input identifying the one or more SQL statements within the set of user selectable SQL statements. The computer program product generates a first prioritized SQL advisor summary based on the set of user selected SQL tuning advisors applied to the one or more SQL statements to determine performance characteristics of the one or more SQL statements, the first prioritized SQL advisor summary containing a visual advisor priority status indicator for each of the user selected SQL tuning advisors. The computer program product displays, when the user selects a first user interface component in the first prioritized SQL advisor summary, recommended action details containing advisor specific SQL tuning recommendations for a selected advisor from the first prioritized SQL advisor summary and executes an advisor specific SQL tuning process in response to the user selecting a second user interface component presented in the recommended action details. In addition, the computer program product generates a second prioritized SQL advisor summary based on the set of user selected SQL tuning advisors applied to the one or more SQL statements after executing the advisor specific SQL tuning process, the second prioritized SQL advisor summary contains an updated visual advisor priority status indicator that indicates the effects of the advisor specific SQL tuning process.

In one embodiment, the first prioritized SQL advisor summary includes an advice summary for each of the user selected SQL tuning advisors, each advice summary including the visual advisor priority status indicator and a summary of detailed advice, the advice summaries presented such that higher priority advice summaries are addressed by a user before lower priority advice summaries.

In another embodiment, the recommended action details comprise specific SQL tuning code recommendations and an explanation thereof, both of which are presented in a separate screen from the first prioritized SQL advisor summary. In one embodiment, the user selected SQL tuning advisors comprise at least one of a statistics advisor, an index advisor, an MQT advisor, a resource advisor, and a query advisor. The visual advisor priority status indicator includes a color coded status indicator representing a suggested order for implementing the advisor specific SQL tuning recommendations. Alternatively, the visual advisor priority status indicator includes a shape coded status indicator representing a suggested order for implementing the advisor specific SQL tuning recommendations.

The apparatus to conduct SQL analysis, in at least one embodiment of the invention, includes a plurality of modules configured to functionally execute a SQL analysis that provides an easily readable high level summary of the SQL analysis and provides a prioritized list of recommended corrective actions to improve the performance of the SQL. These modules in the described embodiments may include at least one of a statistics advisor, an index advisor, a materialized query table (MQT) advisor, a resource advisor, and a query advisor.

The SQL analysis tool of the present invention, in at least one embodiment, is configured to identify SQL for tuning, invoke one or more tuning advisors, select which of the plurality of advisors will be run and included in the summary, and to generate an advisor summary showing recommendations for multiple aspects affecting SQL performance.

The SQL analysis tool of the present invention, in at least one embodiment, may further include two or more of the following: catalog statistic, indexes, MQTs, and SQL rewrite advisors. The tuning advisor summary may be configured to show the prioritized recommendations of multiple advisors, and a colored visual indication of which advisors' recommendations are the most urgent may be presented. Further, the visual indicators may be shaped and/or sized to indicate differences in the urgency of advisors' recommendations, and a textual indication of which advisors' recommendations are the most urgent may be presented in the summary.

The SQL analysis tool of the present invention, in at least one embodiment, may further present a textual advisor status summary indicating when implementation of other advisors' recommendations, i.e., advisors not utilized in the tuning process used to generate the summary, will aid in the analysis and tuning of the SQL. The SQL analysis tool may further provide a recommendation short list for each advisor summarizing the top recommendations, and a visual indication in the short list of the most urgent recommendations may be presented. The SQL analysis tool may further be configured to invoke the display of more details on the recommendations of each advisor, to select and execute the recommendations of each advisor, and to set options that control how advisors run.

In at least one embodiment of the invention, a system configured to conduct SQL analysis and to present the user with a usable and organized summary of the SQL recommended actions is provided. The system may be embodied in hardware or software. In at least one embodiment, the system may include a microprocessor, a memory device, a bus connecting the processor and memory device, and an input/output device in communication with at least the bus. In this embodiment, the SQL may be stored in the memory device, and the processor may execute operations in accordance with a program also stored in the memory device, wherein the program is configured to control the SQL analysis and display functions.

A method of the present invention is also presented for conducting SQL analysis and presenting the user with a usable and organized summary of recommended actions. The method in the disclosed embodiments substantially includes the steps necessary to carry out the functions presented above with respect to the operation of the described apparatus and system. In at least one embodiment, the method includes identifying SQL for tuning, invoking a tuning advisor summary, selecting advisors to be included in the summary, generating an advisor summary showing recommendations for multiple aspects affecting SQL performance by running the advisors selected for the summary, and presenting a prioritized summary of recommended SQL related improvement actions to the user.

In another embodiment of the present invention, a method for tuning SQL is provided. The method generally includes running an advisor specific SQL advisor summary process on a user selected SQL statement and generating an advisor summary containing prioritized SQL tuning advice summaries and a first user selectable component. The method further includes generating and presenting, when the user selects the first user selectable component, recommended action details containing advisor specific SQL tuning recommendations for a selected advisor from the advisor summary and a second user selectable component. The method further includes running an advisor specific SQL tuning process when the user selects the second user selectable component from the recommended action details, and generating another advisor summary containing advice summaries based upon the SQL after running the advisor specific SQL tuning process.

In another embodiment of the invention, a computer program product having a computer readable medium with computer usable program code programmed for SQL tuning thereon is provides. The program is configured to control a method that includes running an SQL advisor summary process using predetermined SQL tuning advisors on a user selected SQL statement, and generating an advisor summary containing a prioritized list of the predetermined SQL tuning advisors and a first user selectable component. The program is further configured to control a process of generating, when the user selects the first user selectable component, recommended action details containing advisor specific SQL tuning recommendations for a selected SQL tuning advisor from the advisor summary and a second user selectable component, running an advisor specific SQL tuning process when the user selects the second user selectable component from the recommended action details, and generating another advisor summary containing prioritized SQL tuning advisors based upon the SQL after running the advisor specific SQL tuning process.

In another embodiment of the invention, a system for SQL tuning is provided. The system generally includes a means for running an SQL advisor summary process using predetermined SQL tuning advisors on a user selected SQL statement, a means for generating an advisor summary containing a prioritized list of the predetermined SQL tuning advisors and a first user selectable component, and a means for generating, when the user selects the first user selectable component, recommended action details containing advisor specific SQL tuning recommendations for a selected SQL tuning advisor from the advisor summary and a second user selectable component. The system further includes a means for running an advisor specific SQL tuning process when the user selects the second user selectable component from the recommended action details, and a means for generating another advisor summary containing prioritized SQL tuning advisors based upon the SQL after running the advisor specific SQL tuning process.

In another embodiment of the invention, a system for tuning SQL is provided. The system generally includes a first running module configured to run an SQL advisor summary process using predetermined SQL tuning advisors on a user selected SQL statement, and a first generating module configured to generate an advisor summary containing a prioritized list of the predetermined SQL tuning advisors and a first user selectable component. The system further includes a second generating module configured to generate, when the user selects the first user selectable component, recommended action details containing advisor specific SQL tuning recommendations for a selected SQL tuning advisor from the advisor summary and a second user selectable component, a second running module configured to run an advisor specific SQL tuning process when the user selects the second user selectable component from the recommended action details, and a third generating module configured to generate another advisor summary containing prioritized SQL tuning advisors based upon the SQL after running the advisor specific SQL tuning process.

Additionally, reference throughout this specification to features, advantages, or similar language does not imply that all of the features and advantages that may be realized with the present invention should be, or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating an exemplary system of the present invention;

FIG. 2 illustrates a flowchart of an exemplary method of the present invention;

FIG. 3 illustrates a screen shot of a program implementing an exemplary SQL analysis process of the present invention, wherein an SQL statement is selected for tuning;

FIG. 4 illustrates a screen shot of a program implementing an exemplary SQL analysis process of the present invention, wherein specific SQL tuning advisors are selected;

FIG. 5 illustrates a screen shot of a program implementing an exemplary SQL analysis process of the present invention, wherein a prioritized advisor summary is presented;

FIG. 6 illustrates a screen shot of a program implementing an exemplary SQL analysis process of the present invention, wherein detailed advisor specific recommendations and explanations are presented;

FIG. 7 illustrates a screen shot of a program implementing an exemplary SQL analysis process of the present invention, wherein a second prioritized advisor summary is presented;

FIG. 8 illustrates a screen shot of a program implementing an exemplary SQL analysis process of the present invention, wherein a second detailed advisor specific recommendations and explanations are presented; and

FIG. 9 illustrates a screen shot of a program implementing an exemplary SQL analysis process of the present invention, wherein a third prioritized advisor summary is presented.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language is intended to mean that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment. Further, Applicants contemplate that various combinations of the embodiments described herein may be had without departing from the scope of the invention.

Further, reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

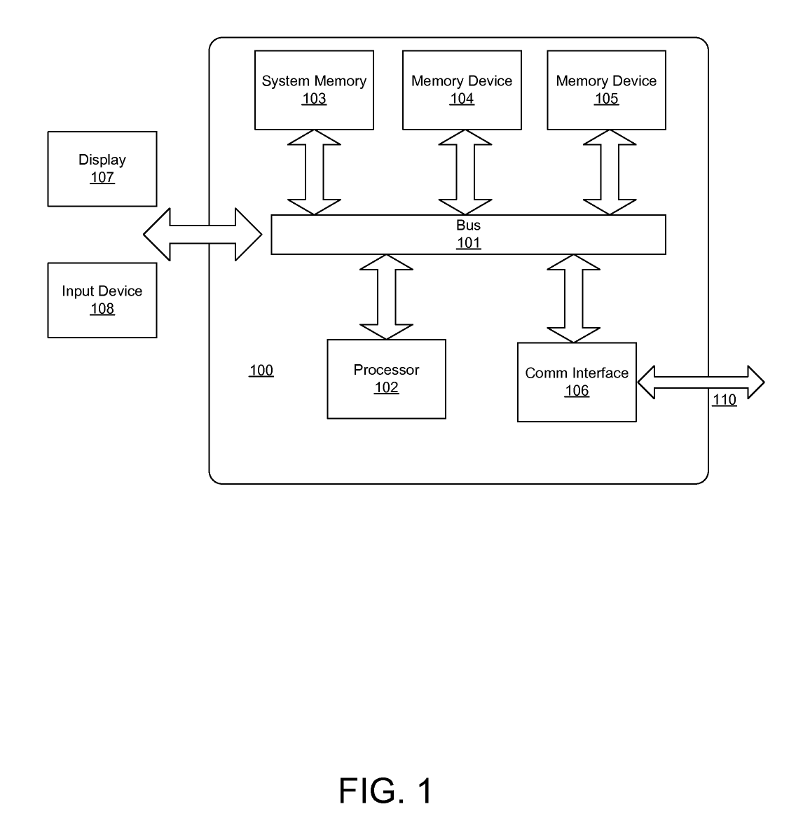

FIG. 1 is a schematic block diagram illustrating an exemplary system 100 of the present invention. System 100 may generally include a system bus 101 that is in communication with a processor 102 and a system memory 103. At least one additional memory device, such as a hard disk drive, server, stand alone database, or other non-volatile memory, may also be in communication with the bus 101. The additional memory devices 104, 105 may be configured to store data, programs, instructions, SQL, and any other information that may be needed to operate a processor or computer. Additionally, the memory devices 104, 105 may also serve as databases or datastores for SQL. Alternatively, system 100 may be configured to access an external database containing SQL for analysis through a communication interface 106, which may be in communication with the system bus 101, and communication link 110. System 100 may further include a user display 107 and an input device 108 for interacting (receiving input and presenting output) with a user.

In operation, system 100 may be used to implement a SQL analysis that provides a prioritized summary of recommended actions. The summary includes visual indicators of the importance of recommended actions in accordance with the present invention. The SQL analysis is conducted with the system 100 performing specific operations via processor 102 executing one or more sequences of instructions contained in system memory 103. Such instructions may be read into system memory 103 from another computer readable medium, such as static storage device 104, 105. The term “computer readable medium” as used herein refers to any medium that participates in providing instructions to processor 103 for execution.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

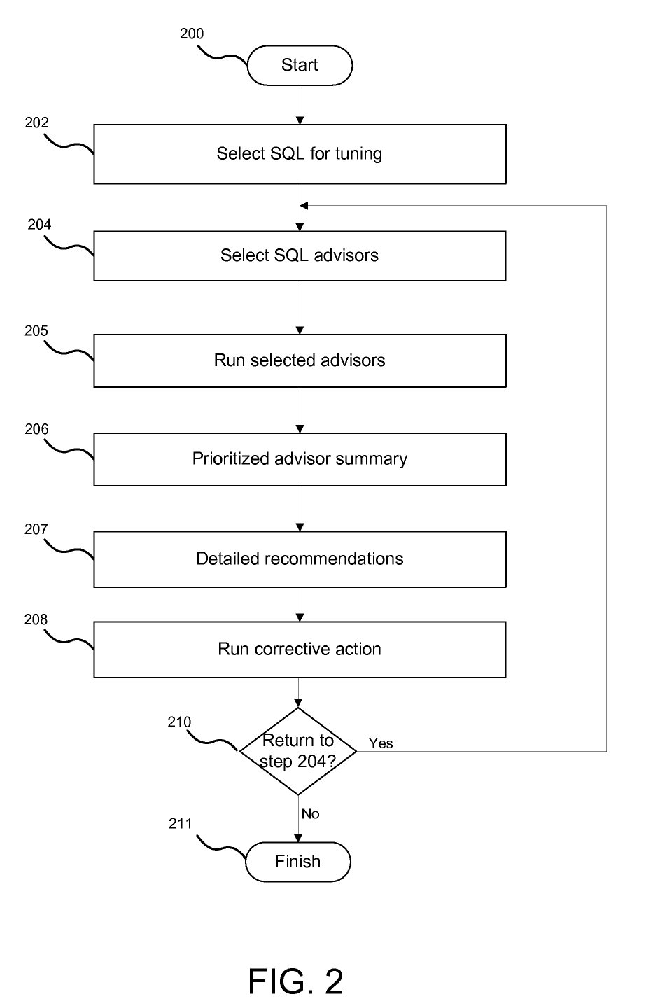

The method of the present invention generally includes a plurality of operations, as illustrated in FIG. 2, which is a flowchart of an exemplary method of the present invention. The exemplary method of the present invention begins 200 and continues to step 202, where an SQL statement is identified for tuning. The identification of the SQL statement for tuning may be made by the user, or alternatively, by an automated process, such as by a SQL analysis program of the present invention, which may be configured to conduct a preliminary test upon SQL statements to determine if the statement is a candidate for optimization. The identification of the SQL statement for analysis can be made from any number of SQL sources, such as lists in the database catalog, external query and reporting tools (such as QMF), the dynamic statement cache, a list of queries identified through a query monitoring tool (such as Query Monitor), or simply imported from a file or copied or typed into a text field.

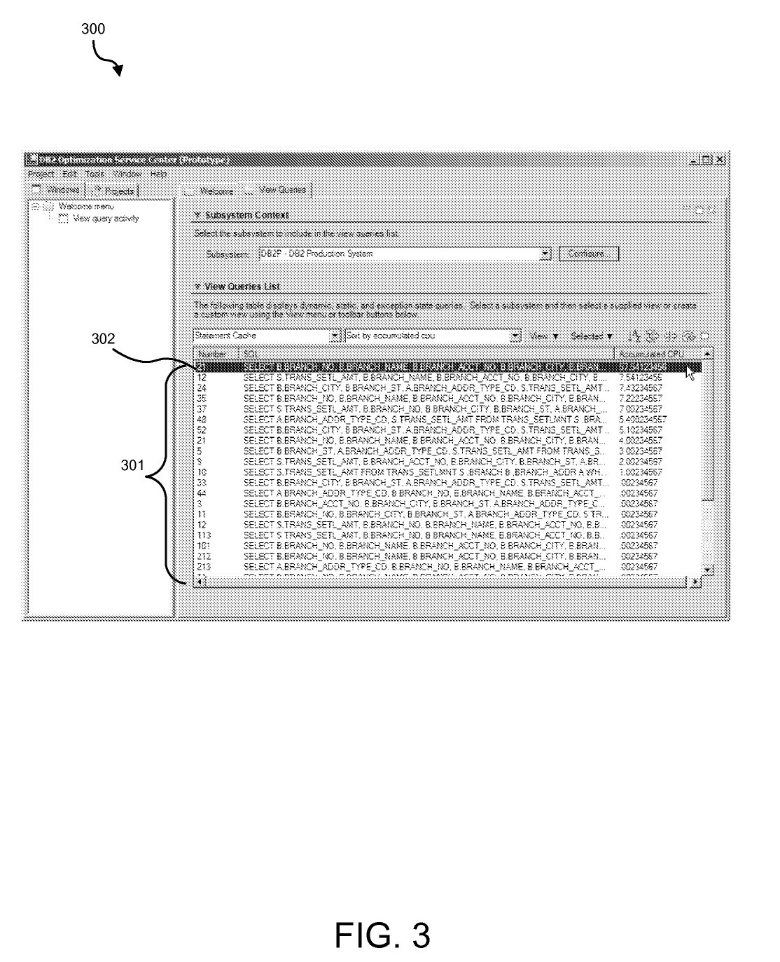

FIG. 3 illustrates an exemplary screen shot 300 of a program implementing the SQL analysis process of the present invention. In FIG. 3, the user is viewing SQL statements 301 in a dynamic statement cache sorted by accumulated CPU usage. It should be noted, however, that the present invention is not limited to presenting SQL statements to the user in the manner illustrated in FIG. 3. Rather, it is contemplated that the SQL statements may be pulled from any subsystem and may be sorted by any parameter common to the SQL statements. Alternatively, a user may type or copy in a SQL statement. The statement at the top 302 in FIG. 3, which is highlighted in the screen shot, has the greatest accumulated CPU usage, and thus, is selected by the user for tuning in the exemplary embodiment. Although any one of the statements listed in the statement cache shown in FIG. 3 or a plurality of statements may be selected for tuning, the user has selected the first statement in the list for optimization, as this statement has the highest accumulated CPU usage (57.54123456) compared to the other SQL statements. Given that the CPU usage for this particular SQL statement is at least eight times greater than any other SQL statement in the cache, the first SQL statement would generally be a good candidate for optimization.

Additionally, although the embodiment of the present invention illustrated in FIG. 3 shows the user selecting the SQL statement for optimization, embodiments of the present invention are not limited to this configuration. In alternative embodiments of the present invention, an automated selection process may be used to select SQL statements for optimization, for example, where statements with the highest accumulated CPU usage or CPU usage above a threshold are sequentially selected for optimization. In embodiments of the present invention where selection of the SQL statements for optimization is automated, various algorithms based on parameters related to the SQL statements themselves may be used to determine the selection process.

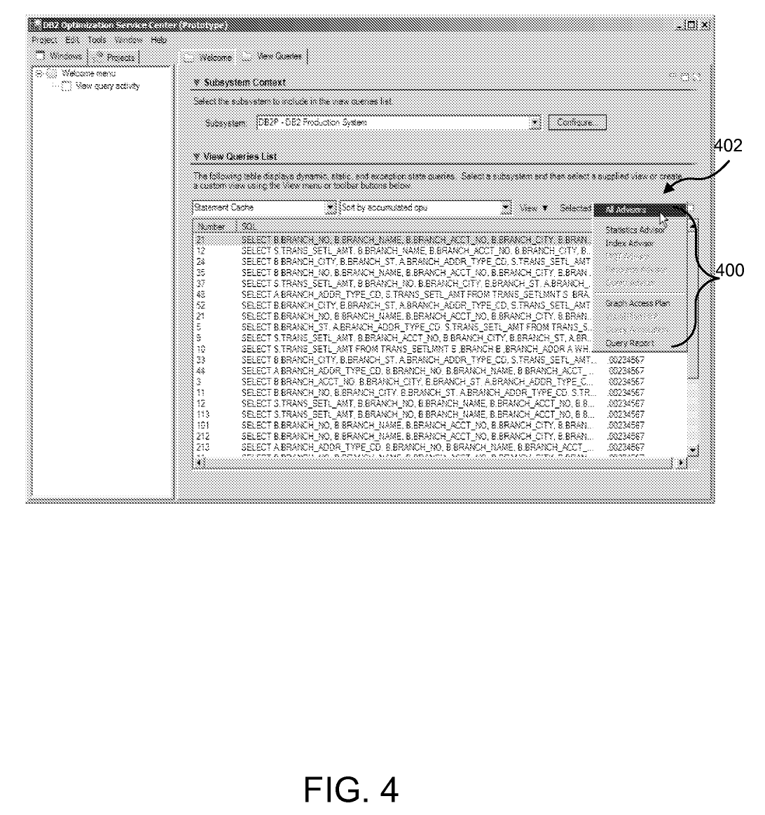

Once a SQL statement has been selected for tuning, the method continues to step 204, where the user selects one or more SQL optimization advisors 400 (See FIG. 4) to analyze characteristics of the SQL and database environment for issues, including design issues, affecting the performance of the SQL, as shown in the screenshot illustrated in FIG. 4. Running the selected advisors may be invoked from one or more user interface components or controls, such as a menu, a set of push buttons, a set of toolbar buttons, etc. However, in the present exemplary embodiment, the user is presented with a drop down menu 402 from which selected advisors can be run. In the exemplary drop down menu presented in FIG. 4, the user has selected to run “all advisors” available, which in the exemplary SQL tuning process, includes the “Statistics Advisor” and the “Index Advisor.” Additional advisors, i.e., the “MQT Advisor,” the “Resource Advisor,” and the “Query Advisor” are not available for the selected SQL statement, and therefore, as shown in FIG. 4, the unavailable advisors are not presented as being available for selection (these advisors are presented in ghost text and cannot be elected).

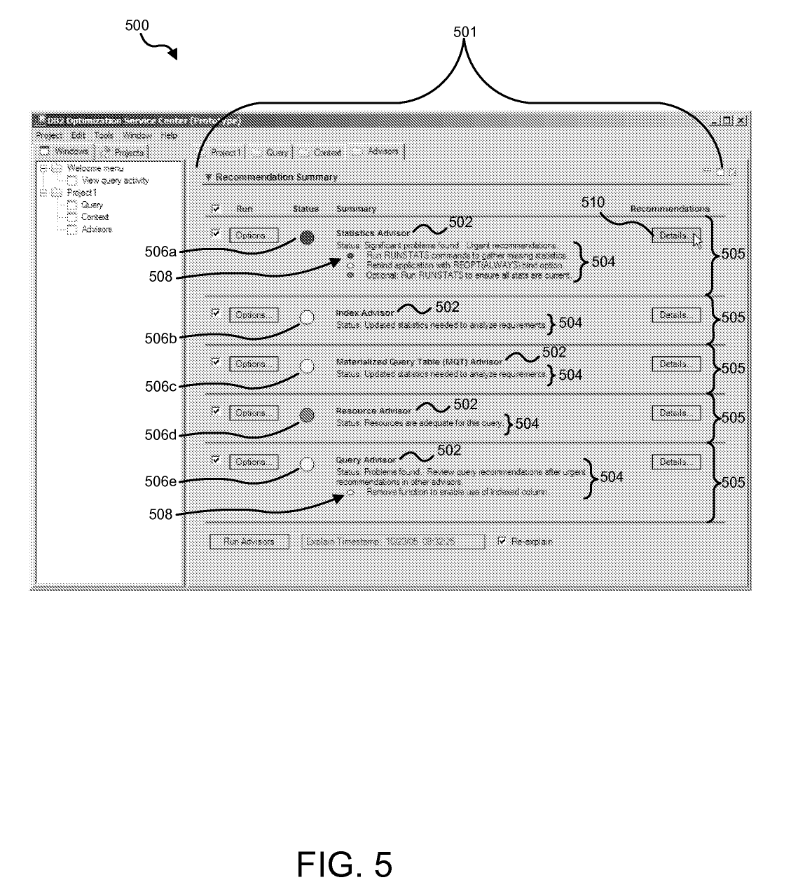

Once the advisors have been selected at step 204, the method continues to step 205, where the selected advisors are run on the selected SQL statement. The selected advisors analyze the SQL statement for flaws that can be adjusted or modified to increase the performance of the SQL statement. Once each of the selected advisors has been run on the SQL statement at step 205, the method continues to step 206, where a prioritized advisor summary is generated and presented to the user. FIG. 5 illustrates a screen shot 500 of an exemplary prioritized advisor summary 501 of the present invention. The prioritized advisor summary 501 shows which advisors 502 were run and the status 504 of their analysis and recommendations.

In one embodiment, the prioritized advisor summary 501 includes an advice summary 505 for each advisor selected. An advice summary comprises a set of specific summary information relating to the operation of the particular advisor. In one embodiment, advice summaries are displayed on a single tab with lines separating the advice summaries 505. Those of skill in the art recognize that advice summaries may be presented in various user interface formats including sub-tabs on a tab control.

In one embodiment, the method presents the advice summaries 505 in a manner that encourages the user to follow advice for one advice summary 505 prior to the advice of others. For example, higher priority advice summaries 505 may be at the top of the screen and lower priority advice summaries 505 may be near the bottom of the screen or within an unscrolled portion. Preferably, the highest priority advice summaries 505 are presented closest to the top and left of the prioritized advisor summary 501 such that the user's attention is first drawn to these higher priority advice summaries 505.

The prioritized advisor summary 501 includes visual advisor priority status indicators 506 to assist the user to quickly identify the most urgent, high priority recommendations. For example, the visual indicators may use the color red (as with indicator 506a) to indicate urgent recommendations, the color yellow (as with indicators 506b, 506c, and 506d) to indicate lower priority recommendations, and green (as with indicator 506e) to indicate when there are no problems resulting in recommendations from a particular advisor. The prioritized advisor summary 501 may also include a text summary 507 of each advisor's recommendation status, indicating when significant problems have been found, when other advisors' recommendations should take priority, such as dependent advisors, and when no problems or recommendations have been found.

In an alternative embodiment, the visual advisor priority status indicator 506 has a distinctive shape indicative of the associated priority. For example, octagon shape may indicate high priority similar to the importance of following a stop sign. A triangle may indicate medium level recommendations similar to the traffic signal for yielding, and a circle shape may indicate lower priority recommendations which may indicate no problems.

When advisor recommendations are available, a list 508 summarizing the recommendations appears under that advisor's status summary text. Having identified which of the advisor's recommendations are the highest priority, the user can drill-down to the recommendation details through a button 510 or other user interface control that if selected by the user will present another screen to the user with further details of the SQL tuning recommendations. The additional screen (generated when button 510 is activated) may be used to activate automatic tuning operations of the SQL statement in accordance with the advisor recommendations 508. Alternatively, the additional screen may present instructions as to how to modify the SQL statement to correct poor performance issues.

In the exemplary screen shot presented in FIG. 5, the Statistics Advisor recommendations are presented as having the highest priority, however, the user has the ability/option to select and implement the Query Advisor recommendations before the recommendations presented by the Statistics Advisor, if desired. This prioritized summary screen illustrating the specific issues for with the selected SQL statement allows the user to select which operations or fixes are to be implemented without suffering any detrimental impact on the SQL statement that generally results from hit and miss-type SQL tuning processes.

With regard to prioritization and/or presentation order of the respective advisors (represented by the advice summaries 505), embodiments of the present invention may generally assign a higher priority to the advisors that provide what is generally referred to as more foundational functions for the SQL. Further, as a result of dependencies between the advisors, when a particular advisor is a high priority for tuning, a dependent or related advisor may also be assigned an increased priority.

For example, in some embodiments of the present invention, if the statistics collection advisor is red (the highest priority in the present exemplary embodiment), then the index advisor would automatically be assigned yellow priority (increased from green), as the index advisor depends on having accurate statistics collection information. Therefore, this priority scheme represents to the user that once the statistics collection advisor is run, then the index advisor should also be executed, as the running of the statistics advisor will have an impact on the related/dependent index advisor. For priority of recommendations within an advisor, or what determines whether it is a red, yellow, or green, it depends on the type of advisor and the recommendations made.

Typically, in the exemplary embodiment of the present invention, foundational, clear, or obvious advisor recommendations will be assigned the highest priority, i.e., red priority. Similarly, advisor recommendations that essentially contain no recommend changes will be assigned the lowest priority, i.e., green priority. Recommendations between the green and red priority may be assigned an intermediate color, i.e., yellow, orange, etc. Thus, multiple levels of priority may be assigned in accordance with the complexity or severity of the recommended tuning recommendation.

More particularly, with regard to the individual advisors (represented by the advice summaries 505) and the priority status assigned thereto, the statistics advisor recommends statistics collection, which in turn, populates the catalogue tables if statistics are missing or conflicting. Therefore, if any problems are identified by the statistics advisor, these problems will generally be assigned high or red priority by the present exemplary embodiment of the present invention. Similarly, statistics advisor generally recommends either a partial statistics collection or a full statistics collection, i.e., partial statistics collection is generally recommended when a single SQL statement is analyzed, and full statistics collection is generally recommended when more than one SQL statement is analyzed in the same application of the advisor tool.

The index advisor projects improvements based on indexes. The index advisor generally uses estimates, but depends on having accurate statistics, as mentions above with respect to the statistics advisor. If no indexes are being used, then a recommendation to use an index is a high priority (red). It may propose a new index and give it a red or yellow designation, depending on the database.

The query advisor looks at the query text and examines its structure. It looks for inefficiencies, for example an embedded SQL function on a date field, where a date index could have been used. These recommendations may depend highly on the data, so if there is an obvious problem, then the red or high priority status may be assigned thereto. The query advisor generally has two levels, where one level estimates the size of the problem, and the other level is a confidence level that the size of the problem as estimated is correct, where the confidence level is generally dependent upon the data. Generally speaking, however, the order of execution of the advisors will not change the priority scheme assigned thereto, as the advisors typically do not change the database, so the recommendations of one do not affect another. However, the order of implementing the tuning recommendations is important i.e., the statistics collection should be before the index corrections. The advisor tuning recommendations may be presented to the user in priority order, i.e., tuning recommendations having higher priority may be presented first in the list of tuning recommendations.

Returning to the discussion of the operation of the exemplary embodiment of the present invention, if the user selects the detail button 510, then the method continues to step 207, where a screen having more information about the recommended changes to optimize the one or more SQL statements is presented to the user.

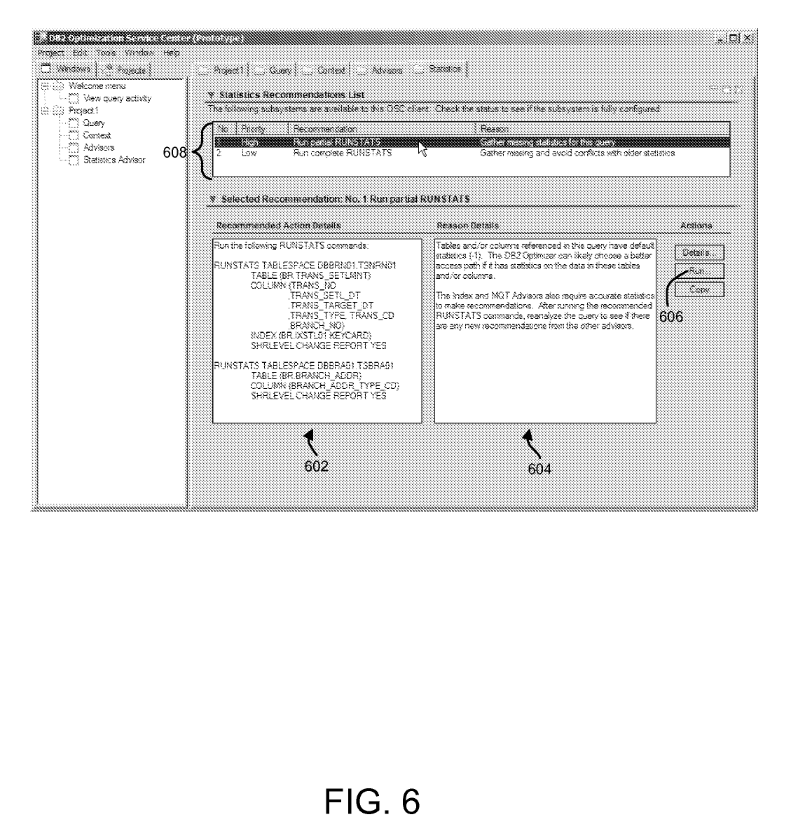

FIG. 6 illustrates a screen shot of an exemplary detailed recommendation screen presented to the user when the detail button 510 is selected. The recommendation screen details include a prioritized list 608 of all recommendations for the corresponding advisor. In addition, for each recommendation listed in the prioritized list, an action details window 602 is presented to illustrate the action that can be taken by the user to address the issue noted in the prioritized list 608. Additionally, a second window presents a detailed explanation 604 of the exact nature of the problem identified by the advisor and how the recommended action will help the identified problem.

Once the detailed recommendation(s) have been presented to the user, the method continues to step 208, where the recommended action (an advisor specific SQL tuning process) can be run directly from the recommendation screen by the user selecting the “Run” button 606, which will cause the program of the present invention to implement the recommended action. Alternatively, the recommended action can be manually executed by the user in another window or program interface that has access to the SQL. Assuming that the user selects the “Run” button 606, the statistics advisor corresponding to the “RUNSTATS” command will activate and will gather the missing statistics for the SQL and will address the statistics conflicts for the SQL, as illustrated in the prioritized list discussion of FIG. 6.

In one embodiment, the availability of the “Run” button 606 is dynamically determined based on the access rights of the user. If a user does not have access rights to perform the specific tuning process, the “Run” button 606 may be unavailable and may be grayed out. In this manner, the present invention further guides and directs a user to perform positive tuning operations while avoiding negative tuning operations by users who are less experienced.

After the statistics recommendation has been implemented, i.e., after step 208 in the present exemplary embodiment, the method continues to step 210, where the user can return to the Advisor Summary screen (as illustrated in FIG. 5) and re-run the selected advisors at step 205 to determine if the SQL issues intended to be addressed by the RUNSTATS command (or other specific SQL tuning process) have been resolved.

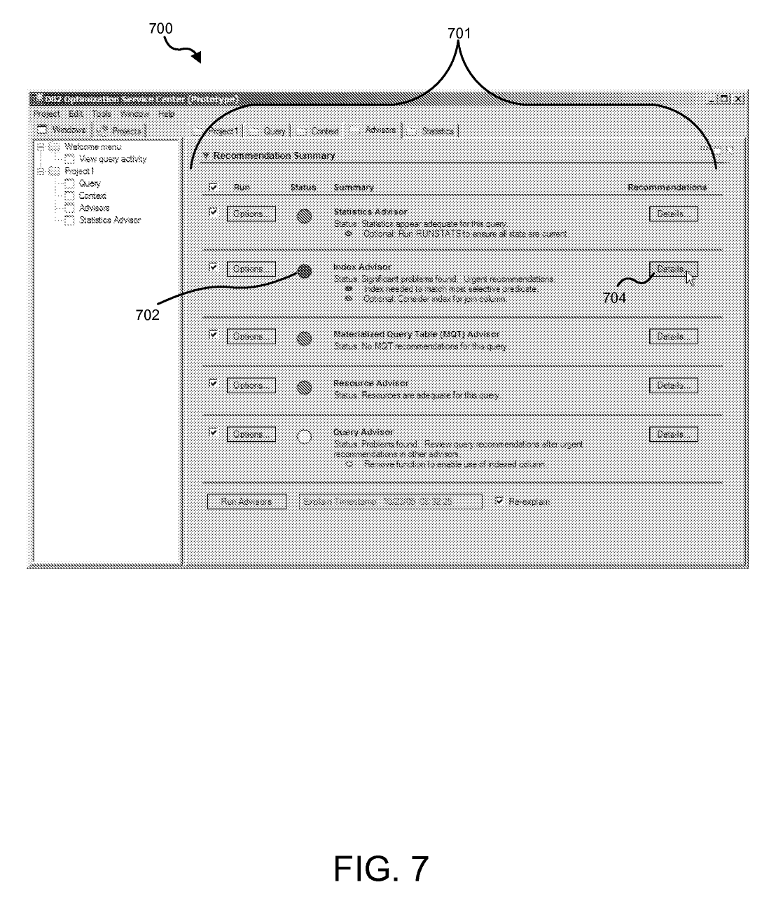

An exemplary Advisor Summary screen 700 representing the status of the advisors (in the form of advice summaries) after the RUNSTATS command has been executed is illustrated in FIG. 7. The second prioritized SQL advisor summary 701, in similar fashion to the summary presented in FIG. 5, includes an option for selecting which of the advisors will be run and an option for setting additional run options for each of the Advisors. In the example shown in FIG. 7, checkboxes are used to select which advisors to run, and again, “Options . . . ” buttons will display dialog windows for setting runtime options.

In the current example, when the advisors are re-run, the Statistics Advisor status indicator turns to green (previously red), thus indicating that the statistics issues have been resolved, and the Index Advisor status indicator turns to red (previously yellow). Thus, the statistics issues have been resolved, however, the statistics collected have enabled the Index Advisor to identify the need for a new index, and as such, the tuning advisor identifies and prioritizes this issue.

The MQT Advisor status indicator turns from yellow to green, indicating that the statistics collected show no need for an MQT. The Query Advisor indicator status is still yellow because it was not affected or corrected by the collection of statistics in the RUNSTATS operation. Therefore, the QUERY ADVISOR issues will still have to be addressed through the process illustrated in FIG. 6 where the user selects the QUERY ADVISOR and runs the recommended corrective actions to tune the SQL.

This stage of the exemplary present invention provides value to users, as the need for guesswork is eliminated from the SQL tuning process through the integration of the prioritized summary of advisor recommendations and the inline advisor tools that can be run from within the program to tune a specific portion of the SQL identified by a particular advisor. In the past, once one issue was corrected, there was no easy or time efficient way to determine if the corrected issue had an impact on other issues. The prioritized summary provided by the present invention eliminates the need for guesswork as to which advisor to run, and also minimizes self destruction of the SQL, i.e., prevents a self tuner from running the wrong advisor and causing more harm to the SQL than good, thus increasing the tuning workload.

Returning to the discussion of the re-run of the Prioritized Summary after the RUNSTATS operation, as noted above, the running of the Statistics Advisor recommended the need for a new index, as shown by the “red” priority status 702 associated with the Index Advisor. The recommendations explain why a new index is recommended, i.e., the most selective predicate in the SQL is not matched in any existing indexes. It also shows the DDL for creating the new index and offers the option to create the index from this window.

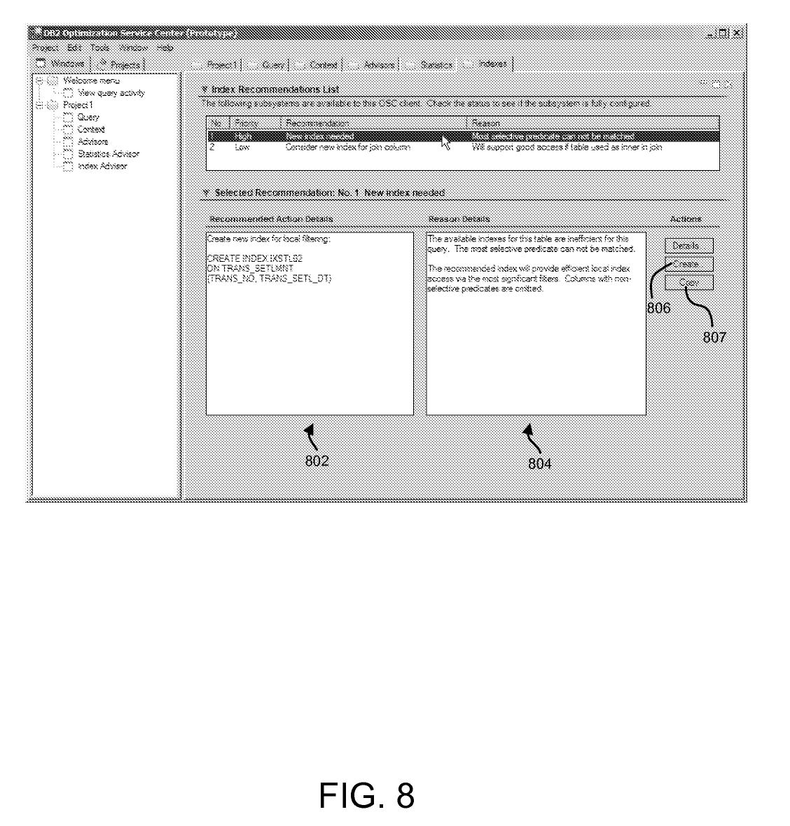

If the details button 704 is selected by the user, then the Index Recommendations List illustrated in FIG. 8 is presented to the user. In similar fashion to the statistics recommendations presented in FIG. 6, the Index Recommendations List includes a recommended actions window 802, a detailed reasons window 804, and an actions button(s) 806. In the present example, the Index Advisor is recommending creating a new index, as illustrated in the first line of the recommended actions window 802. Therefore, if the user selects the create button 806, then the program will create the new index for the user to address the index issue. Alternatively, the user may use the copy button 807 to put the text in the recommended actions window 803 that will generate the new index on the clipboard. The user may then paste the clipboard contents into another tool to create the index. Thereafter, the user can re-run the Advisor Summary to determine if the index issue has been resolved.

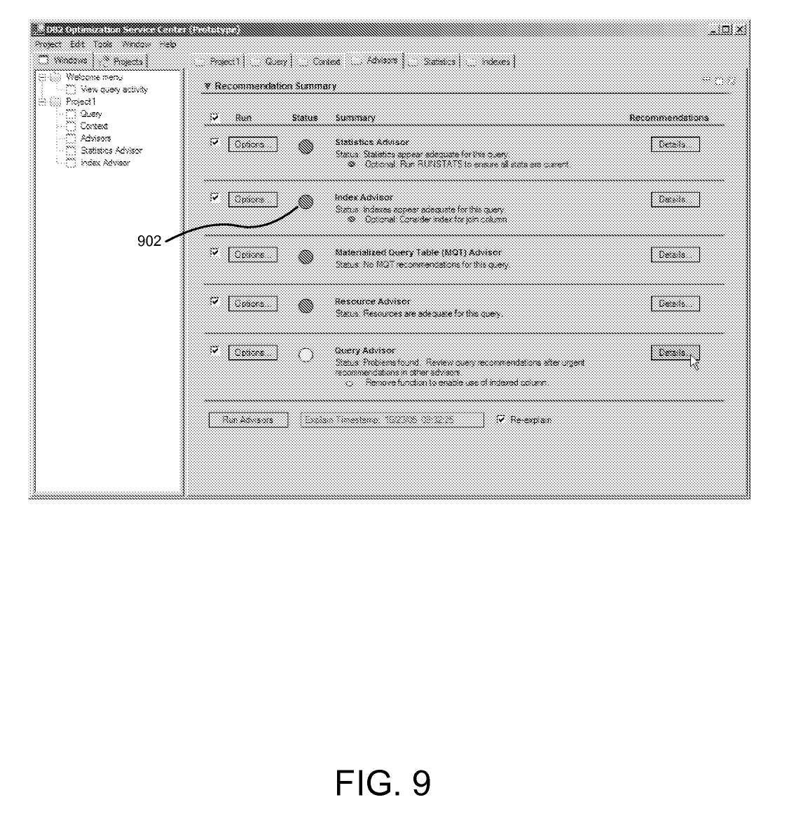

FIG. 9 illustrates an exemplary advisory summary after the index issue has been corrected, where the status indicator 902 for the Index Advisor is green, thus indicating that the index issues have been resolved.

As illustrated in the flowchart of FIG. 2, this process can be continued by the user until each of the selected advisors achieves a “green” status indicator in the recommendation summary (shown in FIGS. 5, 7, and 9). The user will generally repeat the advisor analysis process, as noted in steps 204-208, until the SQL has been properly tuned. Once the SQL statement(s) are properly tuned, the user determines 210 that no more runs of the advisors are necessary and the method ends 211.

An advantage of this method is that the user is presented with the prioritized recommendation summary that indicates which advisors have the higher priority issues to be resolved.

In one embodiment, advice summaries 505 are presented in different order from top to bottom based on the priority of the recommendations (i.e. red indicators higher than green indicators). Alternatively, the advice summaries 505 are presented in the same order.

In the present exemplary embodiment, the prioritized recommendation summary suggested, via a higher priority status (see 506 in FIG. 5), that the Statistics Advisor be run before the Index Advisor. This is valuable to the user, because if the user corrected the index issues prior to the statistics issues, then the user would likely have to start the tuning process over, since after the statistics were corrected, the index would again have to be corrected. The present invention eliminates this conventional challenge by presenting the user with the prioritized recommendation summary.

The present invention may be embodied in other specific forms without departing from its spirit or essential characteristics. The described embodiments are to be considered in all respects only as illustrative, and not restrictive. The scope of the present invention is, therefore, indicated by the appended claims rather than by the foregoing description. All changes which come within the meaning and range of equivalency of the claims are to be embraced within their scope.

What is claimed is:

1. A computer program product to summarize advice from a plurality of SQL advisors and coordinate, and prioritize implementation of the advice from the plurality of SQL advisors for a specific SQL statement, comprising a computer useable medium having a computer readable program thereon, wherein the computer readable program, when executed on a computer, causes the computer to:
present a set of user selectable SQL statements associated with a particular relational database;
select one or more SQL statements for tuning in response to user input identifying the one or more SQL statements within the set of user selectable SQL statements;
generate a first prioritized SQL advisor summary based on the set of user selected SQL tuning advisors applied to the one or more SQL statements to determine performance characteristics of the one or more SQL statements, the first prioritized SQL advisor summary containing a visual advisor priority status indicator for each of the user selected SQL tuning advisors;
display, when the user selects a first user interface component in the first prioritized SQL advisor summary, recommended action details containing advisor specific SQL tuning recommendations for a selected advisor from the first prioritized SQL advisor summary;
execute an advisor specific SQL tuning process in response to the user selecting a second user interface component presented in the recommended action details; and
generate a second prioritized SQL advisor summary based on the set of user selected SQL tuning advisors applied to the one or more SQL statements after executing the advisor specific SQL tuning process, the second prioritized SQL advisor summary containing an updated visual advisor priority status indicator that indicates the effects of the advisor specific SQL tuning process.

2. The computer program product of claim 1, wherein first prioritized SQL advisor summary includes an advice summary for each of the user selected SQL tuning advisors, each advice summary including the visual advisor priority status indicator and a summary of detailed advice, the advice summaries presented such that higher priority advice summaries are addressed by a user before lower priority advice summaries.

3. The computer program product of claim 1, wherein the recommended action details comprise specific SQL tuning code recommendations and an explanation thereof, both of which are presented in a separate screen from the first prioritized SQL advisor summary.

4. The computer program product of claim 1, wherein the user selected SQL tuning advisors comprise at least one of a statistics advisor, an index advisor, an MQT advisor, a resource advisor, and a query advisor.

5. The computer program product of claim 1, wherein the visual advisor priority status indicator comprises a color coded status indicator representing a suggested order for implementing the advisor specific SQL tuning recommendations.

6. The computer program product of claim 1, wherein the visual advisor priority status indicator comprises a shape coded status indicator representing a suggested order for implementing the advisor specific SQL tuning recommendations.

7. An apparatus for tuning SQL, comprising:
a display module configured to present a set of SQL statements associated with a particular relational database;
a selection module configured to allow a user to select a SQL statement for tuning from the set of SQL statements and one or more SQL tuning advisors to be applied to the selected SQL statement; and
an execution module configured to generate a first prioritized SQL advisor summary based on the one or more user selected SQL tuning advisors applied to the user selected SQL statement to determine performance characteristics of the SQL statement, the first prioritized SQL advisor summary containing an advice summary for each of the user selected SQL tuning advisors, the advice summary including a visual advisor priority status indicator, the execution module is further configured to generate, when the user selects a first user interface component in the first prioritized SQL advisor summary, recommended action details containing advisor specific SQL tuning recommendations for a selected advisor from the SQL advisor summary, the recommended action details being displayed to the user on the display module, the execution module is further configured to execute an advisor specific SQL tuning process when the user selects a second user interface component presented in the recommended action details and to display a second advisor specific SQL advisor summary containing advice summaries based upon the identified SQL statement after executing the advisor specific SQL tuning process on the display module, the advice summaries presented such that higher priority advice summaries are addressed by a user before lower priority advice summaries.

8. The apparatus for tuning SQL recited in claim 7, wherein the execution module comprises a memory device in communication with a micro-processor via a bus, the bus also being in communication with the display module.

9. The apparatus for tuning SQL recited in claim 7, wherein the recommended action details comprise specific SQL tuning code recommendations and an explanation thereof, both of which are presented in a separate screen from the first prioritized SQL advisor summary.

10. The apparatus for tuning SQL recited in claim 7, wherein the visual advisor priority status indicator comprises a color coded status indicator representing a suggested order for implementing the advisor specific SQL tuning recommendations.

11. A system for tuning SQL, comprising a computer processor, at least one memory device in communication with the processor via a system bus, a display device in communication the system bus, and a user input device in communication with the system bus, the system for tuning SQL being configured to:
present a set of user selectable SQL statements associated with a particular relational database on the display device;
receive a user selected an SQL statement for tuning and user selected SQL tuning advisors from the user input device;
generate, with the processor, a prioritized SQL advisor summary based on the user selected SQL tuning advisors applied to the SQL statement for tuning to determine performance characteristics of the SQL statement for tuning, the first prioritized SQL advisor summary being displayed the user with the display and containing a visual advisor priority status indicator for each of the user selected SQL tuning advisors;
generate, with the processor and when the user selects a first user interface component in the prioritized SQL advisor summary, recommended action details containing advisor specific SQL tuning recommendations for a selected advisor from the SQL advisor summary, the recommended action details being displayed to the user on the user device;
execute, with the processor, an advisor specific SQL tuning process when the user selects a second user interface component presented in the recommended action details with the input device; and
generate, with the processor, a revised advisor specific SQL advisor summary containing prioritized SQL tuning advisors based upon the identified SQL statement after executing the advisor specific SQL tuning process and displaying the second advisor specific advisor summary to the user on the display device.
